(19) United States
(12) Patent Application Publication
(10) Pub. No.: US 2016/0327113 A1
(43) Pub. Date: Nov. 10, 2016

(54) APPARATUS, SYSTEM, AND METHOD FOR ABSORBING MECHANICAL ENERGY

(71) Applicant: Kevin Shelley, Salt Lake City, UT (US)

(72) Inventor: Kevin Shelley, Salt Lake City, UT (US)

(21) Appl. No.: 15/150,216

(22) Filed: May 9, 2016

Related U.S. Application Data
(60) Provisional application No. 62/158,431, filed on May 7, 2015.

(51) Int. Cl. F16F 7/12; G02C 5/00; A44C 5/00; A41D 13/06; A41D 13/05

(52) U.S. Cl. CPC F16F 7/121; A41D 13/065; A41D 13/0543; A44C 5/0053; G02C 5/008; F16F 2226/00; A47G 9/10

(57) ABSTRACT

Apparatuses, systems, and methods are disclosed for absorbing mechanical energy. An apparatus includes a vented layer formed with a plurality of vent openings. A vent opening includes a channel extending through the vented layer to permit airflow through the vented layer. An array of protrusions extends away from the vented layer. The array of protrusions allows air from the vent openings to flow between the protrusions. In some embodiments, the protrusions absorb energy by deformation such that one or more of the protrusions deforms significantly by bending toward the vented layer.

### CROSS-REFERENCES TO RELATED APPLICATIONS

This application claims the benefit of U.S. Provisional Patent Application No. 62/158,431 entitled “APPARATUS, SYSTEM, AND METHOD FOR ABSORBING MECHANICAL ENERGY” and filed on May 7, 2015 for Kevin Shelley, which is incorporated herein by reference.

### FIELD

This invention relates to absorbing mechanical energy and more particularly relates to a breathable material for absorbing mechanical energy of impacts, vibrations, pressures, and the like.

### BACKGROUND

Various types of material absorb mechanical energy by compression or deformation, to absorb impacts, dampen vibrations, support weight, distribute pressure, and the like. For example, a resilient foam pad may absorb energy by compression to distribute the energy of a short impact over a longer time, to distribute steady pressure on a smaller area over a larger area, or the like. A person may wear, stand on, sit on, or otherwise contact a variety of energy absorbing materials that are used in a wide variety of applications, such as providing comfortable cushioning for daily activities, or providing impact protection for sports. However, many types of energy absorbing materials may trap sweat, retain body heat, rub against skin, or otherwise cause discomfort or irritation. Even in applications where the energy absorbing material is not in contact with a person, certain materials may undesirably retain dirt, liquids, odors, and the like.

### SUMMARY

Apparatuses, systems, and methods are disclosed for absorbing mechanical energy. In one embodiment, an apparatus includes a vented layer formed with a plurality of vent openings. In a further embodiment, a vent opening includes a channel extending through the vented layer to permit airflow through the vented layer. In a certain embodiment, an array of protrusions extends away from the vented layer. In a further embodiment, the array of protrusions allows air from the vent openings to flow between the protrusions. In some embodiments, the protrusions absorb energy by deformation such that one or more of the protrusions deforms significantly by bending toward the vented layer.

In one embodiment, a structural framework includes an array of linear members that extend along and are coupled to the vented layer. In a further embodiment, the vented layer, the protrusions, and the structural framework are formed integrally as a single piece of polymer material.

In one embodiment, the array of protrusions is formed to manage airflow between the protrusions. In a certain embodiment, one or more of the protrusions includes a rounded tip. In some embodiments, the array of protrusions includes at least a first type of protrusion and a second type of protrusion. In further embodiments, the second type of protrusion may be different from the first type of protrusion. In one embodiment, a configuration for a first portion of the array of protrusions differs from a configuration for a second portion of the array of protrusions. In a certain embodiment, a first modular piece may be removably coupled to a second modular piece. In a further embodiment, the first modular piece includes the first portion of the array of protrusions and the second modular piece includes the second portion of the array of protrusions. In one embodiment, a configuration for the array of protrusions is based on one or more measured characteristics of a surface the protrusions are configured to contact.

In one embodiment, a hard layer may be coupled to the vented layer to distribute an impact force across the apparatus. In a further embodiment, the hard layer may include a plurality of vent openings corresponding to vent openings of the vented layer. In a certain embodiment, the vented layer is coupled to a first object such that the protrusions contact a second object when the first object is in use. In some embodiments, the vented layer and the protrusions are molded as a flat piece and bent to form a three-dimensional shape.

An apparatus, in another embodiment, includes a lattice of structural members. In a certain embodiment, the structural members include linear members and/or planar members. In some embodiments, the lattice is formed with a plurality of openings within the lattice. In further embodiments, the openings may permit airflow in multiple directions through the lattice. In a certain embodiment, the lattice absorbs mechanical energy by deformation.

In one embodiment, the lattice is formed by additive manufacturing. In another embodiment, the lattice includes a plurality of molded layers. In a certain embodiment, a first layer of the plurality of molded layers is offset from a second layer of the plurality of molded layers. In a further embodiment, the second layer is adjacent to the first layer.

In one embodiment, a plurality of protrusions extend from the lattice. In a further embodiment, one or more protrusions of the plurality of protrusions includes a flanged base allowing the one or more protrusions to be removed from the lattice and reinserted into the lattice. In a certain embodiment, a configuration for a first portion of the lattice differs from a configuration for a second portion of the lattice.

An apparatus, in still another embodiment, includes a plurality of beads. In a certain embodiment, the beads include structural members, including linear members and/or planar members. In a further embodiment, the beads are formed with openings permitting airflow through the beads. In one embodiment, the beads absorb mechanical energy by deformation. In some embodiments, an enclosure may contain the beads. In one embodiment, the plurality of beads includes at least a first type of bead and a second type of bead. In a further embodiment, the second type of bead may be different from the first type of bead.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a top view illustrating one embodiment of an apparatus for absorbing mechanical energy;

FIG. 1B is an enlarged side view further illustrating the apparatus of FIG. 1;

FIG. 2 illustrates various embodiments of protrusions for use with an apparatus for absorbing mechanical energy;

FIG. 3 illustrates further embodiments of protrusions for use with an apparatus for absorbing mechanical energy

FIG. 4 illustrates various embodiments of structural framework for use with an apparatus for absorbing mechanical energy;

FIG. 5 illustrates embodiments of structural members for use with an apparatus for absorbing mechanical energy;

FIG. 6 illustrates one embodiment of a lattice of structural members;

FIG. 7 illustrates further embodiments of a lattice of structural members, including protrusions;

FIG. 8 illustrates further embodiments of a lattice of structural members, including protrusions;

FIG. 9 illustrates various embodiment of beads for use with an apparatus for absorbing mechanical energy;

FIG. 10A illustrates a flat molding for another embodiment of an apparatus for absorbing mechanical energy;

FIG. 10B illustrates folds for the flat molding of FIG. 10A;

FIG. 10C illustrates the folded flat molding of FIG. 10A, forming a complex shaped embodiment of an apparatus for absorbing mechanical energy;

FIG. 11 illustrates one embodiment of a system for absorbing mechanical energy;

FIG. 12 illustrates another embodiment of a system for absorbing mechanical energy;

FIG. 13 illustrates another embodiment of a system for absorbing mechanical energy;

FIG. 14 illustrates another embodiment of a system for absorbing mechanical energy;

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

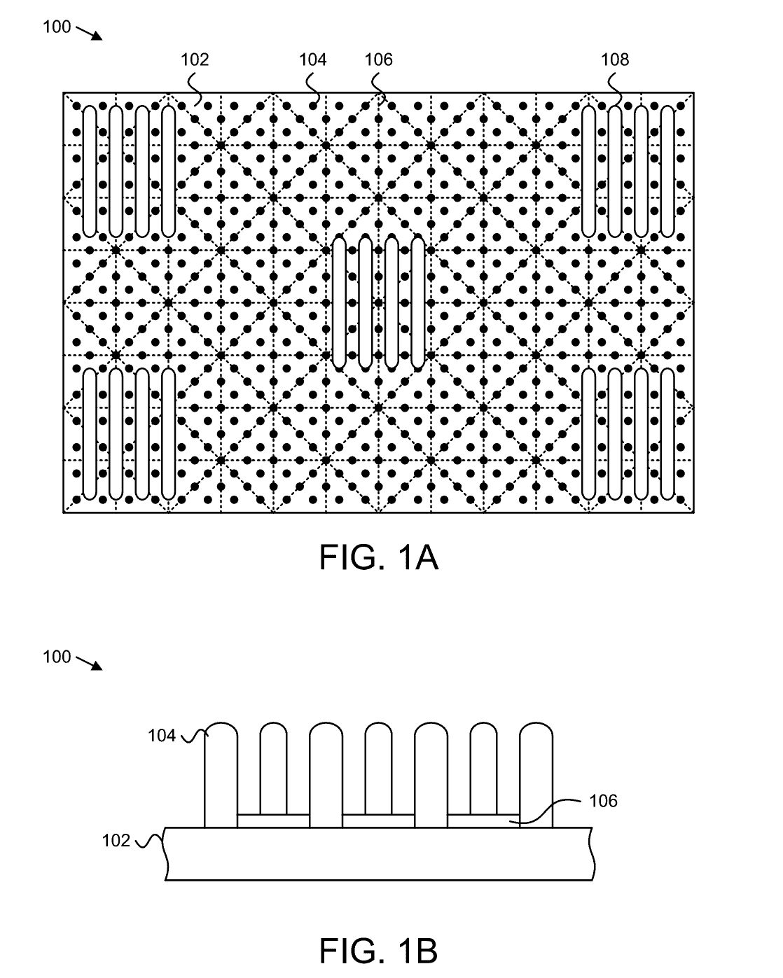

FIG. 1A depicts a top view of one embodiment of an apparatus 100 for absorbing mechanical energy. In the depicted embodiment, the apparatus 100 includes a vented layer 102, an array of protrusions 104, and a structural framework 106. In the depicted embodiment, the vented layer 102 is formed with a plurality of vent openings 108. FIG. 1B depicts an enlarged side view of the apparatus 100 for absorbing mechanical energy, including the vented layer 102, protrusions 104, and structural framework 106.

In various embodiments, “absorbing” mechanical energy may refer to receiving and dissipating energy, in the manner of a shock absorber, and/or to receiving, temporarily storing, and re-releasing energy, in the manner of a spring. Thus, in general, an apparatus 100 for absorbing mechanical energy may absorb impacts, dampen vibrations, support weight, distribute pressure, or the like. A vented later 102 may be formed with vent openings 108 that permit airflow through the vented layer 102. Permitting airflow, in various embodiments, may allow sweat to evaporate, allow heat to dissipate, or the like. Protrusions 104 may absorb energy by deformation: the protrusions may deform significantly by bending toward the vented layer 102 when sufficient force is applied. In a certain embodiments, in magnets may be embedded in the vented layer 102 to interact with other magnetic objects, providing another way (apart from deformation of the protrusions 104) to absorb energy (e.g., by repelling another magnetic object). An array of protrusions 104 may also allow air from the vent openings 108 to flow between the protrusions 104.

The vented layer 102, in one embodiment, may be a base layer for the apparatus 100. As used herein, terms such as “base,” “top,” “up,” “down,” “upper,” “lower,” “horizontal,” “vertical,” refer to an orientation in which protrusions 104 extend upwards, away from the vented layer 102, as shown in FIG. 1B. These terms are used, where applicable, to provide some clarity of description when dealing with relative relationships. However, these terms are not intended to imply absolute relationships, positions, and/or orientations. For example, with respect to an object, an “upper” surface can become a “lower” surface simply by turning the object over. Nevertheless, it is still the same object. Similarly, an apparatus 100 for absorbing mechanical energy may be reversed so that the protrusions 104 extend down from the vented layer 102, or may be turned so that the vented layer 102 is to the side of the protrusions 104, but the vented layer 102 may still be described as a base layer.

In various embodiments, a “base layer” may refer to a portion of the apparatus 100 upon which additional portions of the apparatus 100, such as the structural framework 106, protrusions 104, or the like, may be formed, or to which the additional portions may be attached. Thus, in various embodiments, a “base layer” may be a layer other than a bottom layer for the apparatus. For example, the apparatus 100, in the embodiment depicted in FIG. 1B, includes protrusions 104 and a structural framework 106 above the vented layer 102; however, in another embodiment, the protrusions 104 may be above the vented layer 102, and the structural framework 106 may be below the vented layer 102, so that the vented layer 102 is a middle layer for the apparatus 100. Nevertheless, the vented layer 102 may still be described as a base layer.

In certain embodiment, the vented layer 102 may be flat, or have a substantially uniform thickness, so that the apparatus 100 forms a sheet that may be used in a similar variety of impact and energy absorbing applications as a sheet of foam. In another embodiment, however, the vented layer 102 may form a three-dimensional shape, or be formed integrally with a three-dimensional shape, such as a wedge, a cube, or a more complex shape.

In a certain embodiment, the vented layer 102 may be flexible, so that the apparatus 100 can bend to conform to the surface of a piece of sporting equipment, a body part, or another object. In another embodiment, however, the vented layer 102 may be rigid, or difficult to bend, so that the apparatus 100 substantially maintains its shape absent another object. In one embodiment, a hard layer (not shown) may be coupled to a flexible vented layer 102 to distribute an impact force across the apparatus 100. For example, in one embodiment, a shin guard may include a hard front layer that distributes an impact force from soccer cleats, a hockey stick, or the like, over the front of the shin, and the vented layer 102, and protrusions 104 may be on the inside of the shin guard. In a further embodiment, a hard layer may also include a plurality of vent openings corresponding to the vent openings 108 of the vented layer 102, so that airflow is not restricted by the hard layer.

The vented layer 102, in the depicted embodiment, is formed with a plurality of vent openings 108. In a further embodiment, a vent opening 108 may include a channel extending through the vented layer 102 to permit airflow through the vented layer 102. In some embodiments, the vent openings 108 provide airflow to prevent heat, moisture, sweat, or the like from accumulating. The vent openings 108, in certain embodiments, may cooperate with the protrusions 104 described below to allow airflow to flow freely around the entire apparatus 100 to dry and cool it. In some embodiments, however, an apparatus 100 for absorbing mechanical energy may be formed with a non-vented base layer.

In certain embodiments, the vent openings 108 may be disposed at positions within the apparatus 100 that provide flexibility for the apparatus 100 to conform to an object. Because the vent openings 108 provide both ventilation and flexibility, many different configurations of vent openings 108 may be used in the various embodiments of the apparatus 100 to provide desired levels of flexibility, either uniformly, or with variation across various portions of the apparatus 100.

The array of protrusions 104, in the depicted embodiment, extends away from the vented layer 102. In various embodiments, a “protrusion” may refer to a discrete raised portion of the apparatus 100, distinct from other protrusions 104. In further embodiments, a protrusion 104 may be coupled to the vented layer 102, and spaced some distance apart from other protrusions 104. In one embodiment, a protrusion 104 may extend directly from the vented layer 102. In a certain embodiment, another protrusion may extend from the structural framework 106. In general, in various embodiments, protrusions 104 may extend away from the vented layer 102 from various portions of the apparatus 100. Thus, in the depicted embodiment, some protrusions 104 extend directly from the vented layer 102, and further protrusions 104 extend from the structural framework 106. In the depicted embodiment, the array of protrusions 104 is on one side of the vented layer 102, and extends away from the vented layer 102 in one direction. In another embodiment, the array of protrusions 104 may be disposed on two or more surfaces of the vented layer 102, and the protrusions 104 may extend away from the vented layer 102 in two or more directions.

In various embodiments, an “array” of protrusions 104 may refer to a plurality of spaced protrusions 104. In one embodiment, the array of protrusions may allow air from the vent openings 108 to flow between the protrusions 104. In various embodiments, allowing air to flow between the protrusions 104 allows evaporation and cooling to occur across substantial portions of the apparatus 100. Thus, in a certain embodiment, a portion of the apparatus 100 that is not directly adjacent to a vent opening 108 may experience cooling and evaporation due to air flow between the protrusions 104. In a further embodiment, an apparatus 100 with an array of protrusions 104 above and below the vented layer 102 may allow airflow above and below the vented layer 102. For example, in one embodiment, a saddle may include an energy-absorbing apparatus 100 to absorb impacts between a horse and a rider, and protrusions 104 may extend upwards and downwards from a vented layer 102 of the saddle to allow airflow between the rider and the saddle, and between the horse and the saddle.

In certain embodiments, the protrusions 104 may absorb energy by deformation. In a further embodiment, one or more of the protrusions 104 may deform significantly by bending toward the vented layer 102, in response to a force exceeding a threshold. For example, in one embodiment, protrusions 104 may deform or compress slightly in response to small amounts of force, but may buckle or bend over in response to a larger amount of force, exceeding a threshold. A threshold amount of force for buckling or bending over protrusions 104 may be selected or configured by a manufacturer of the apparatus 100 by configuring the width, cross section, material, or similar aspects of the protrusions 104. In a further embodiment, the protrusions 104 may return to an extended position when the amount of force is reduced. By bending over (e.g., toward the vented layer 102), the protrusions 104 may dissipate some energy, and/or store energy that is released when the protrusions 104 return to the extended position. Additionally, the time for a protrusion 104 to bend over and/or return to the extended position may distribute the energy of a short impact over a longer time.

The structural framework 106, in the depicted embodiment, comprises an array of linear members that extend along and are coupled to the vented layer 102. In various embodiments, a linear member may refer to an element in the form of a straight or curved line. In various embodiments, a linear member that extends along and is coupled to a portion of the vented layer 102 may strengthen that portion of the apparatus 100 by resisting tensile or compressive forces applied along the linear member. Thus, in one embodiment, an array of linear members may act as a skeleton or frame to provide strength across the apparatus 100. In a further embodiment, linear members of the structural framework 106 may intersect or extend in various directions, to provide strength in multiple directions that resists tension, compression, bending, and twisting. In the depicted embodiment, the linear members of the structural framework 106 intersect to create a pattern of repeating triangles. In another embodiment, however, the shape of the structural framework 106 may be different.

In one embodiment, the structural framework 106 may be formed as an integral part of the vented layer 102. For example, in the depicted embodiment, the linear members of the structural framework 106 are raised portions of the vented layer 102. (Equivalently, recesses may be formed in the vented layer 102 leaving a structural framework 106 of thicker linear members between the recesses.) In another embodiment, the structural framework 106 may be formed separately from the vented layer 102, and embedded in or attached to the vented layer 102. For example, in one embodiment, a carbon fiber, aramid fiber, or similar structural framework 106 may be embedded in an injection-molded vented layer 102. In another embodiment, a stiff structural framework may be simply attached to the vented layer 102. Thus, in various embodiments, a structural framework 106 may be disposed at the top, at the bottom, or in the middle (e.g. embedded within) the vented layer 102. In a certain embodiment, a structural framework 106 embedded in (or otherwise coupled to) the vented layer 102 may include trapped air, such as an air-filled network of connected linear members, or an array of independent air-filled pockets. In a further embodiment, trapped air in the structural framework may provide rigidity to the structural framework 106 if the air is sufficiently pressurized, or may provide a further way to absorb energy, by compression of the air in the structural framework 106 in response to an applied force.

In certain embodiments, a structural framework 106 coupled to a vented layer 102 may provide strength equivalent to a significantly thicker vented layer 102 without a structural framework 106. Thus, in certain embodiments, using a structural framework 106 may reduce the weight of the apparatus 100, as well as the amount of material used, while still providing sufficient strength. In another embodiment, however, an apparatus 100 for absorbing mechanical energy may not include a structural framework 106. For example, in a certain embodiment, if a heavier apparatus 100 is desirable for a particular application, a thicker vented layer 102 may take the place of a structural framework 106. As another example, in some embodiments, an apparatus 100 may be coupled to an object, such as a shin guard, knee pad, glasses frame, or the like, that supports the apparatus 100 without the use of an array of linear members forming a structural framework 106.

In one embodiment, the vented layer 102, protrusions 104, and structural framework 106 may be formed integrally as a single piece of polymer material. In a certain embodiment, a polymer material that forms the vented layer 102, protrusions 104, and structural framework 106 may primarily include one or more polymers such as nylon, polypropylene, thermoplastic elastomer, thermosetting elastomer, natural or synthetic rubbers, and the like. In various embodiments, a polymer material that forms the vented layer 102, protrusions 104, and structural framework 106 may or may not include additional, non-polymeric components, such as glass fibers, or the like. For example, in one embodiment, a glass-filled nylon material may form the vented layer 102, protrusions 104, and structural framework 106. In another embodiment, however, a mixture of thermoplastic elastomer and polypropylene material may form the vented layer 102, protrusions 104, and structural framework 106. In certain embodiments, a vented layer 102, protrusions 104, and structural framework 106 formed integrally as a single piece of polymer material may be easily cleaned or rinsed, to avoid retaining dirt, odors, moisture, or the like.

In various embodiments, various materials that form the vented layer 102, protrusions 104, and structural framework 106 may provide different levels of flexibility or stiffness. In certain embodiments, where the vented layer 102, protrusions 104, and structural framework 106 are formed integrally as a single piece, it may be desirable for the protrusions 104 to be more or less flexible than the vented layer 102 and/or the structural framework 106. In a further embodiment, the configuration of the protrusions 104 and of the structural framework 106 may be selected to provide different levels of flexibility using the same material. For example, in one embodiment, a thick structural framework 106 may keep the base layer stiff, while narrow protrusions 104 may bend easily to absorb soft impacts. In a certain embodiment, a material with a durometer hardness of 30 Shore A, or in a range from 20 Shore A to 40 Shore A may have soft, flexible protrusions 104 that bend easily even if the protrusions 104 are short or wide. By contrast a material with a durometer hardness of 70 Shore A, or in a range from 60 Shore A to 80 Shore A may have harder protrusions 104 that do not bend easily unless the protrusions are longer or narrower.

In one embodiment, an energy-absorbing apparatus 100 may be produced by a 3D printing process, also referred to as additive manufacturing, in which successive layers of material are extruded, cured, sintered, or otherwise deposited to form an object. In another embodiment, an energy-absorbing apparatus 100 may be produced by molding. In some embodiments, the multiple features of the apparatus 100, including protrusions 104 and a structural framework 106, may involve extended amounts of time for mold tooling. In one embodiment, the mold tooling time is reduced by first creating a pattern of holes in the mold corresponding to the protrusions 104, then using a three-dimensional model to cut the recesses in the mold corresponding to a raised structural framework 106, as well as the rest of the mold. Thus, instead of using a small tool to cut the mold in one pass, a larger or courser tool may be used to save time on a first pass, drilling holes for the protrusions 104, and then the smaller tool could be used to complete the details such as a pattern of hexagons or other shapes for a structural framework 106 on a second pass. Drilling holes for the protrusions 104 first, in some embodiments, may reduce tooling time by approximately an order of magnitude compared to using one tool to cut all the features of the mold.

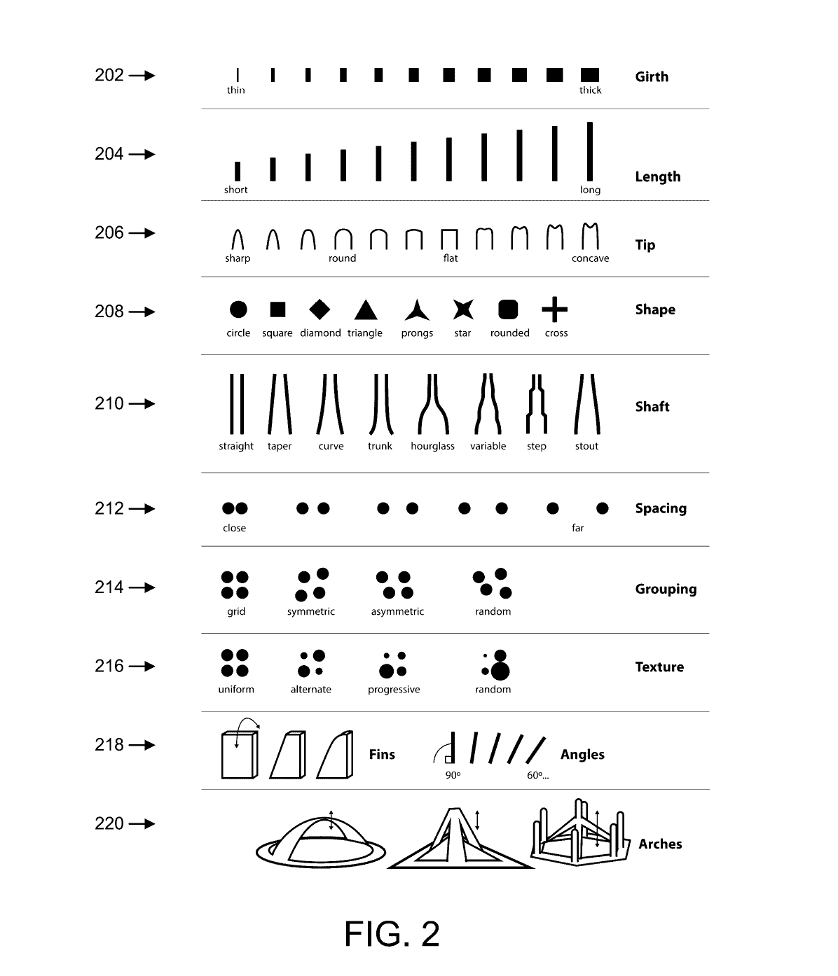

In general, different configurations for the protrusions 104 and/or the structural framework 106 of an apparatus 100 for absorbing mechanical energy may be suitable for different uses or applications. Various example configurations for the protrusions 104 and the structural framework 106 are described below with reference to FIGS. 2, 3, and 4. In various embodiments, an energy-absorbing apparatus including an array of protrusions 104 may be used to provide comfort, cushioning, cooling (due to airflow between protrusions 104), heat isolation (if airflow between protrusions 104 is restricted), shock or impact absorption, sound dampening, vibration dampening, a massaging or invigorating effect that promotes circulation, support for a load, traction or an anti-slip effect, and/or moisture removal (e.g., the protrusions 104 allow sweat to travel away from a user's body and to evaporate in the air flowing between protrusions 104), or the like. A variety of uses for an energy-absorbing apparatus 100 will be clear in view of this disclosure.

In various embodiments, an energy-absorbing apparatus 100 may be used in various applications for any of the purposes described above. For example, in one embodiment, a mobile phone cover or case may include an anti-slip and drop-resistant energy absorbing apparatus 100. In certain embodiments, an apparatus 100 may be used to provide impact resistance (and comfortable cushioning) in a shin guard, helmet, shoulder pad, knee or elbow pad, gym mat, or the like, or underneath an artificial turf playing field. In further embodiments, an apparatus 100 may be used to cushion a seat, a steering wheel, a bicycle or motorcycle seat or handlebars, a saddle, a shoe insole, a floor mat, a watch band, a hat band, a utility belt, a holster, a backpack strap, a back support, a mattress, a medical device, or the like. In some embodiments, a small apparatus 100 for absorbing mechanical energy may provide cushioning inside clothing, at the bridge and/or earpieces of a pair of glasses, or the like. Protrusions 104 may provide anti-slip effects for an anti-slip mat that catches items coming off a conveyor belt, an anti-slip pad with airflow for a laptop, or the like, an anti-slip mat that prevents dishes from sliding in a sink or drain rack, an anti-slip beverage holder, an anti-slip layer on the bottom of a food tray, or the like. In another embodiment, an energy-absorbing apparatus 100 with protrusions may provide vibration damping, shock absorption, and/or cooling for electronics or other machines. In certain embodiments, an energy-absorbing apparatus may be used to protect an object during shipping, to protect easily bruised fruit in transit, to retain or radiate heat for hot food, or the like. In one embodiment, an energy-absorbing apparatus may be applied to the floor, walls, and/or ceiling of a room, or to surfaces in the room, to provide soundproofing or other protective surfaces. A variety of further applications for an energy absorbing apparatus 100 will be clear in view of this disclosure.

In various embodiments, the apparatus 100 for absorbing mechanical energy may be worn in direct or indirect contact with a user, as part of a shin guard, watch band, or the like. When the apparatus 100 is in contact with a user, the protrusions 104 may be nearest to the user, so that sweat is not trapped, and so that air may flow through the protrusions 104 between the user and the vented layer 102. Similarly, a hard layer that distributes impact force may, in some embodiments, be embedded in the vented layer 102 or disposed adjacent to the vented layer 102 on an opposite side from the protrusions 104, so that the protrusions 104 are still nearest the user.

Further embodiments of vented layers 102, protrusions 104 and structural frameworks 106 are described with reference to the frames, extension members, and recesses described in U.S. patent application Ser. No. 14/066,555, entitled “ADAPTIVE CAMOUFLAGE” and filed Oct. 29, 2013 for Kevin Shelley, which is incorporated herein by reference in its entirety.

FIG. 2 depicts various embodiments of protrusions for use with an apparatus 100 for absorbing mechanical energy. In one embodiment, the protrusions of FIG. 2 may be substantially similar to the protrusions 104 described above with reference to FIG. 1A and FIG. 1B. In general, the different protrusions of FIG. 2 are configured differently to have different characteristics with regard to energy absorption, airflow, and the like. Various configurations for individual protrusions, or for the array of protrusions, may be selected according to an intended use for an energy-absorbing apparatus.

In the depicted embodiment, protrusions 202 vary in thickness. In various embodiments, thinner protrusions may be more likely to bend, and thicker protrusions may be more likely to compress in response to an applied force. Similarly, in the depicted embodiment, protrusions 204 vary in length. In various embodiments, taller protrusions may be more likely to bend than shorter protrusions. In a further embodiment, taller protrusions may cast shadows across the apparatus 100 if the apparatus 100 is used in the sun, thus avoiding solar heating of the vented layer 102.

In the depicted embodiment, a tip shape varies for protrusions 206. In one embodiment, a protrusion with a sharp or rounded tip shape may bend easily, whereas a protrusion with a flat or concave tip shape may be less likely to bend, unless the applied force includes a significant horizontal component. In certain embodiments, a protrusion with a concave or wavy tip shape may provide an anti-slip effect.

In the depicted embodiment, protrusions 208 vary in cross sectional shape, and protrusions 210 have varying profiles. In certain embodiments, the cross-sectional shape of a protrusion may affect the direction in which the protrusion is likely to bend, or may affect the airflow around the protrusion. In some embodiments, the profile of a protrusion may make the protrusion more or less likely to bend at varying points along its length. For example, in one embodiment, a stepped protrusion may be narrower at the top than at the bottom, so that the top portion bends easily when a lower level of force is applied, and the bottom portion allows the protrusion to bend further when a higher level of force is applied. In the depicted embodiment, the profiles for the protrusions 210 are straight, or narrower at the tip of the protrusions, allowing the protrusions and the vented layer to be formed together in a simple mold. In another embodiment, if protrusions with the tip wider than the base may be desirable, a more complex mold may be used, a wider protrusion tip may be plastic welded to a narrower protrusion, or a narrower protrusion may be dipped in additional material to form a wider tip.

In the depicted embodiment, a spacing between protrusions 212 varies. In one embodiment, closely spaced protrusions may distribute an applied force across multiple protrusions in a region of the apparatus 100, but may also restrict airflow. In another embodiment, more distantly spaced protrusions may allow more airflow between the protrusions, but may increase the amount of force applied to each protrusion.

In the depicted embodiment, a grouping or pattern varies for different regions of protrusions 214. In one embodiment, protrusions in a repeating grid or symmetric pattern may, as a group, be more likely to bend in a particular direction that reduces the likelihood of collisions between adjacent protrusions. In another embodiment, groups of protrusions in an asymmetric or random pattern may be more likely to bend in any direction because, on average, collisions between adjacent protrusions may happen with approximately equal likelihood in any direction.

In the depicted embodiment, protrusions 216 provide varying textures by being mixed together in different ways. For example, a uniform array of protrusions may provide a uniform texture, but different mixtures of protrusions may provide varying textures. For example, longer, narrower protrusions may be mixed with shorter, wider protrusions, so that the longer protrusions begin to bend in response to a lower level of force, and the shorter, wider protrusions begin to bend in response to a higher level of force, once the taller protrusions are partially bent.

In the depicted embodiment, protrusions 218 vary in shape and angle. For example, in one embodiment, post-shaped protrusions (as previously illustrated) may bend in any direction. In another embodiment, fin- or ridge-shaped protrusions 218 may bend more easily across the width of the protrusions, and may resist being bent along the length of the fin or ridge. In one embodiment, a protrusion may be vertical, at a 90 degree angle from the vented layer. In another embodiment, a protrusion may extend away from the vented layer at another angle. Protrusions that extend away from the vented layer at an angle other than 90 degrees may bend more easily than vertical protrusions, and may preferentially bend in one direction. In the depicted embodiment, protrusions 220 include arched or vaulted portions that extend from at least two different points on the structural framework to meet above the structural framework.

In general, it is clear that many different characteristics of individual protrusions (e.g., width, length, tip, shape, profile) and of the array of protrusions (e.g., spacing, pattern) may be varied or selected to affect a variety of characteristics for the apparatus 100, such as the way the protrusions bend, the threshold force required to bend a protrusion, the way air flows between the protrusions, or the like. In one embodiment, the array of protrusions may be formed to manage airflow between the protrusions. In various embodiments, managing airflow may include allowing air to flow freely, or restricting airflow to some degree. For example, in one embodiment, protrusions may be narrow, rounded, and/or widely spaced, so that air flows freely between the protrusions, to provide a cooling effect. In another embodiment, however, protrusions may be wider, more closely spaced, or may be shaped with recesses that trap air (e.g., with a star or cross shaped cross section), so that air flow is restricted to some extent between the protrusions, to provide an insulating effect.

In another embodiment, the apparatus may include multiple different types of protrusions, which may vary in individual characteristics, such as width, length, shape, or the like. For example, in one embodiment, a first type of protrusion may differ from a second type of protrusion. As a further example a first type of protrusion may have a different profile, and therefore a different response to applied force, than a second type of protrusion. In view of this disclosure, many ways of configuring an energy absorbing apparatus with multiple types of protrusions are clear.

In one embodiment, a configuration for a first portion of the array of protrusions differs from a configuration for a second portion of the array of protrusions. In various embodiments, a “configuration” for the array of protrusions, or for a portion of the array, refers to characteristics of individual protrusions and array-based characteristics such as spacing or grouping of protrusions. In general, in various embodiments, various portions of the array of protrusions may have different configurations based on the intended use of the apparatus for absorbing mechanical energy. For example, in one embodiment, if the apparatus will be used to cushion a backpack strap, different portions of the array of protrusions may have different configurations so that the threshold force sufficient to bend the protrusions is different over bony parts of the shoulder and over soft tissue, or for portions that are expected to bear different amounts of weight.

In one embodiment, the configuration of protrusions may change gradually between different portions of the array of protrusions. In another embodiment, the configuration of protrusions may change distinctly at distinct boundaries between portions of the array of protrusions. For example, in one embodiment, the protrusions may change continuously across a region from narrow protrusions that bend more easily to wide protrusions that bend less easily.

In another embodiment, the apparatus may comprise removably coupled modular pieces, with potentially separate configurations for the array of protrusions on each modular piece. For example, if a configuration for a first portion of an array differs from a configuration for a second portion of the array, then a first modular piece may comprising the first portion of the array may be removably coupled to a second modular piece comprising the second portion of the array. Modular pieces may include squares, strips, or other shapes that can be removably coupled to form a larger apparatus. For example, in one embodiment, one inch modular squares or strips may be assembled with various configurations of protrusions to produce a customized energy-absorbing pad for a shin guard, knee pad, backpack strap or the like. In another embodiment, eight or twelve inch modular tiles may be assembled to create a customized shock absorbing floor mat. In certain embodiments, coupling modular pieces to form an apparatus for absorbing energy may allow a large variety of customized apparatuses to be created without creating a correspondingly large array of customized molds. In one embodiment, modular pieces may be removably coupled edge to edge, to customize an array of protrusions across its width. In another embodiment, modular pieces may be removably stacked, creating stacks that include multiple vented layers and multiple arrays of protrusions. In view of this disclosure, many possible sizes, shapes, and configurations of modular pieces, and many possible ways to couple modular pieces to form an energy-absorbing apparatus are clear.

In one embodiment, a configuration for the array of protrusions may be based on one or more measured characteristics of a surface or object the protrusions are configured to contact. For example, if the apparatus is to be used to cushion a watchband, measurements of an individual user's wrist may be made at different points so that the protrusions provide more cushioning at harder or bonier parts of the wrist. In one embodiment, an apparatus for absorbing mechanical energy may be produced on demand by 3D printing, after measuring characteristics of the body part or object the protrusions are configured to contact.

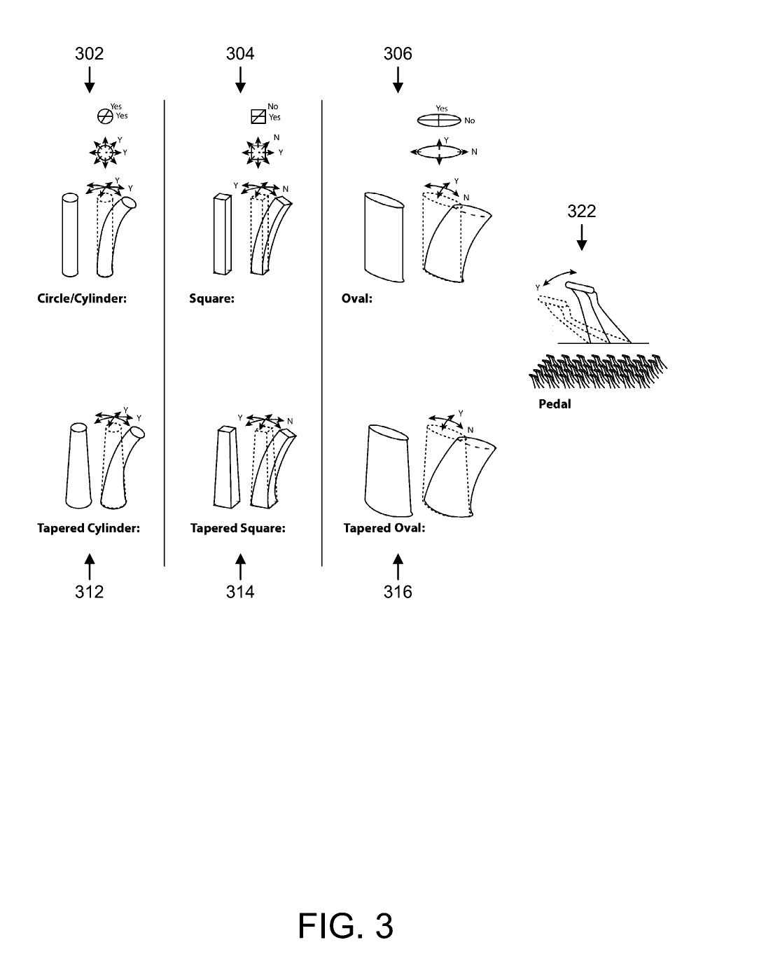

FIG. 3 illustrates further embodiments of protrusions for use with an apparatus 100 for absorbing mechanical energy. In various embodiments, the protrusions of FIG. 3 may be substantially similar to the protrusions described above with reference to FIG. 1A, FIG. 1B, and FIG. 2. In general, the different protrusions of FIG. 3 are configured differently to have different characteristics with regard to energy absorption, airflow, and the like. Various configurations for individual protrusions, or for the array of protrusions, may be selected according to an intended use for an energy-absorbing apparatus.

In the depicted embodiment, as described above with regard to protrusions 208, 210 of FIG. 2, protrusions 302, 304, 306, 312, 314, and 316 vary in cross-sectional shape and profile. In the depicted embodiment, protrusions 302 are cylindrical, or have a circular cross section, protrusions 304 have a square cross section, and protrusions 306 include an oval cross section. In certain embodiments, cylindrical protrusions 302 may be similarly likely to bend in any direction. Conversely, protrusions with a square, oval, or other non-circular cross section may be more likely to bend in certain directions and less likely to bend in other directions. For example, protrusions 304 with a square cross section may be more likely to bend in a direction parallel with an edge of the square, and less likely to bend in a direction parallel with a diagonal of the square. Similarly, protrusions 306 with an oval cross section may be more likely to bend in the direction in which the oval is narrower, and less likely to bend in the direction in which the oval is wider. Additionally, cylindrical protrusions 302 may facilitate airflow in any direction. Conversely, square or oval protrusions 304, 306 may allow airflow in some directions, but obstruct airflow in other directions. For example, protrusions 306 with an oval cross section may block or impede airflow incident on the broader sides of the protrusions 306, but facilitate airflow incident on the narrower sides of the protrusions 306. In view of this disclosure, many cross-sectional shapes for protrusions that facilitate or impede airflow in different directions will be clear.

In the depicted embodiment, protrusions 312, 314, and 316 include circular, square, and oval cross sections, similar to protrusions 302, 304, and 306 respectively. Additionally, the profile of protrusions 312, 314, and 316 is tapered, so that the protrusions are wider at the bottom than at the top. In a certain embodiment, a tapered protrusion such as protrusions 312, 314, or 316 may bend more easily at a top portion of the protrusion, and may bend further at a lower, wider part of the protrusion if additional force is applied.

In the depicted embodiment, protrusions 322 are tapered, are narrower in one direction, so as to preferentially bend in that direction, and are angled in the that direction (i.e., they extend away from the vented layer, structural framework, or the like, in the same direction in which the protrusions preferentially bend). Additionally, although the protrusions 322 generally taper so that they are narrower near the top than near the bottom, each protrusion includes a broader top. A protrusion 322 with a top portion broader than a portion beneath the top portion may be formed by 3D printing, by using a complex mold, by gluing or plastic welding the broader top portion to the narrower portion beneath the top portion, or the like. Thus, protrusions 322 may be similar in some ways to a pedal, with a broader contact surface connected to a narrower shaft. The broader contact surface of protrusions 322 may distribute pressure to provide comfort for applications where a user's hand, foot, or other body part contacts the protrusions.

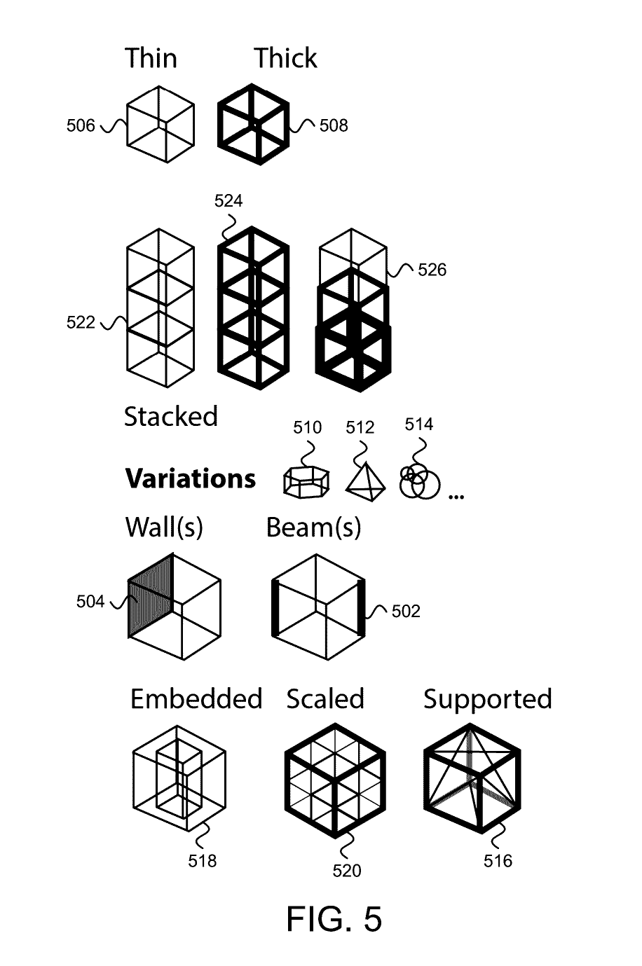

In various embodiments, protrusions as depicted in FIGS. 2 and 3 may attach to or extend away from a substrate. Without a substrate, protrusions might simply be moved to a horizontal position, rather than deformed to absorb mechanical energy. By contrast, connecting protrusions to a substrate, or building a substrate with protrusions extending away from the substrate positions the protrusions in such a way that the protrusions may deform to absorb mechanical energy. In one embodiment, a substrate may be a vented layer and/or a structural framework as described above with regard to FIGS. 1A and 1B. In another embodiment, a substrate may be a lattice or bead as described with regard to FIGS. 5 through 9. In various embodiments, however, a vented layer, lattice, bead, or other substrate may be formed with openings to facilitate airflow through both the protrusions and the substrate.

In certain embodiments, various configurations of protrusions as depicted in FIGS. 2 and 3 may facilitate various uses of an apparatus 100 for absorbing mechanical energy. Complex shapes or configurations of protrusions may manage airflow, provide firmer or softer portions, or otherwise provide benefits that a more uniform array of bristles or protrusions may not provide.

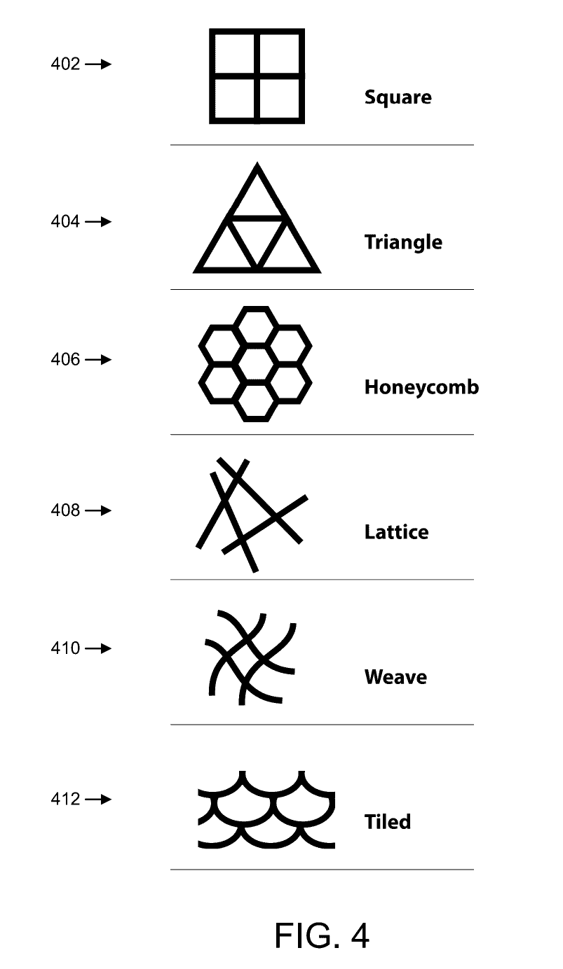

FIG. 4 depicts various embodiments of structural framework for use with an apparatus 100 for absorbing mechanical energy. In one embodiment, the structural framework of FIG. 4 may be substantially similar to the structural framework 106 described above with reference to FIG. 1A and FIG. 1B. In general, the different structural frameworks of FIG. 4 are configured differently to have different characteristics with regard to strength, flexibility, and the like. Various configurations for a structural framework may be selected according to an intended use for an energy-absorbing apparatus.

In the depicted embodiment, structural framework 402 includes linear members in a square pattern, providing strength in two directions. Structural frameworks 404, 406 include linear members in triangular and hexagonal patterns, providing strength in three directions. In another embodiment, structural framework 408 includes linear members in a randomly arranged lattice. A random arrangement of linear members may provide strength in multiple directions. In the depicted embodiment, structural frameworks 410, 412 include curved linear members, in a weave or tiled configuration. Like straight linear members, curved linear members in some embodiments may also provide strength by resisting tensile and/or compressive forces along their length.

In one embodiment, an apparatus for absorbing energy may be molded as a flat piece, with gaps that meet when the flat piece is bent or folded to form a more complex shape. In a further embodiment, a structural framework may have corresponding gaps. For example, pentagons may be added to the hexagonal structural framework 410, so that gaps in the apparatus correspond to gaps between pentagons of the structural framework.

FIG. 5 depicts embodiments of structural members for use with an apparatus for absorbing mechanical energy. In various embodiments, an apparatus for absorbing mechanical energy may include a three-dimensional lattice of structural members, a plurality of individual beads comprising structural members, or the like. In general, in various embodiments, a lattice or a plurality of beads may be formed with openings permitting airflow, and may absorb mechanical energy by deformation, as further described below.

In various embodiments, structural members may include beams or linear members 502 and/or walls or planar members 504. As described above with regard to the structural framework 106 of FIGS. 1A and 1B, a linear member 502 may be a structural member in the form of a straight or a curved line. Similarly, a planar member 504 may be a structural member in the form of a flat or curved surface. Structural elements or members, in various embodiments, may include one or more polymers such as nylon, polypropylene, thermoplastic elastomer, thermosetting elastomer, natural or synthetic rubbers, and the like. Further material suitable for forming structural members will be clear in view of this disclosure.

In certain embodiments, structural members may be coupled to form cells. As used herein, a cell refers to a collection of structural members surrounding a volume. For example, in one embodiment, a cell may be a cube 506, 508, with linear members forming the edges of the cube. A variety of configurations of cells are suitable, in various embodiments, for absorbing mechanical energy. In various embodiments, the width or thickness of structural members may vary. For example, cube 506 is a cell formed of thinner structural members than cube 508. The width or thickness of structural members may vary between cells, or within cells. In some embodiments, cells may surround non-cubic volumes. For example, a cell may be in the shape of a prism 510, a tetrahedron 512 or other regular or irregular polyhedron, or may be formed by the intersection of multiple cells 514. FIG. 5 primarily depicts cells in which linear members form the edges of the cell. However, in various embodiments, planar members may form one or more faces of a cell. Additionally, as depicted in cell 516, linear members may provide further structure to the cell by crossing faces of the cell, thereby supporting or stabilizing the cell.

In certain embodiments, cells may be combined to form nested or stacked cells. For example, in one embodiment, as depicted by cell 518, a smaller cell may be embedded in a larger cell. In another embodiment, as depicted by cell 520, a larger cell may include multiple embedded, scaled copies of itself. In certain embodiments, cells may be stacked to form columns, rows, grids, or the like. For example, column 522 includes multiple cubic cells 506 formed of thinner structural members. Similarly, column 524 includes multiple cubic cells 508 formed by thicker structural members. In certain embodiments, cells may vary in thickness, shape, or the like within a column or other array, as in column 526.

In certain embodiments, cells may form lattices or individual beads. A lattice may refer to a collection of cells connected to fill a space. For example, a lattice may comprise a row, column, grid, layers of grids or the like, formed by combining cells. In one embodiment, a lattice may be ordered, repeating, periodic, or the like. For example, in one embodiment, a may be formed by multiple identical or similar cells. In another embodiment, a lattice may be random or disordered. For example, an open-cell or closed-cell foam may include a random lattice of cells. By contrast, a bead may refer to an individual cell, or a small number of connected cells, and a space may be filled by a plurality of separate beads. Cells forming a plurality of beads may have more freedom to move, relative to other cells, than cells that form a lattice.

In various embodiments, cells, columns, lattices, beads, or the like may absorb mechanical energy by deformation. For example, linear or planar structural members, and the cells, beads, columns lattices, or the like, formed by such structural members may bend, buckle, fold, twist, or the like, as force is applied. As described above with regard to the protrusions 104 of FIG. 1A and FIG. 1B, absorbing mechanical energy may refer to receiving and dissipating energy, in the manner of a shock absorber, and/or to receiving, temporarily storing, and re-releasing energy, in the manner of a spring. Cells, structural members and the like may deform to dissipate or to temporarily store and re-release energy.

As further described above with regard to multiple embodiments of protrusions described in connection with FIG. 2 and FIG. 3, various aspects of structural members and cells, including thickness, length, cross-sectional shape, profile, cell shape, cell size, and the like may be configured to control the deformation of structural members for various reasons. In general, in various embodiments, various collections of cells may have different configurations based on the intended use of the apparatus for absorbing mechanical energy. For example, if an apparatus for absorbing mechanical energy is used as a cushion or pad, thicker structural members may provide firmer padding, and thinner structural members may provide softer padding.

In some embodiments, a configuration for a first portion of a lattice differs from a configuration for a second portion of the lattice. For example, if a lattice will be used to cushion a mattress, different portions of the lattice may provide regions of different firmness for the mattress. Similarly, in another embodiment, a plurality of beads may include at least two different types of bead. Additionally, in certain embodiments, a lattice may have a directional configuration, so that the lattice is firmer in one direction, and softer or more flexible in another direction. In certain embodiments, a configuration for a lattice, beads, one or more portions of a lattice, or one or more types of beads may be determined based on one or more measured characteristics of a surface or object the energy-absorbing apparatus is configured to contact. For example, a lattice to absorb mechanical energy may be included in an orthopedic insole, a socket for a prosthesis, or the like, to cushion the impact between the user and the shoe, the prosthesis or other device. In a certain embodiment, biometric measurements of the user's foot or other limb may be made, including measurements of shape, tissue softness or hardness, and the like. In a further embodiment, a configuration for the lattice (or for protrusions extending from the lattice) may be algorithmically determined based on the biometric measurements. In certain embodiments, configuring portions of a lattice or protrusions based on measured characteristics of a surface or object the energy-absorbing apparatus is configured to contact may provide a closer fitting, more comfortable, or better ventilated lattice than a lattice configured without regard to measured characteristics.

A lattice of cells, or a plurality of individual beads, may be formed with openings permitting airflow. Individual cells may permit or restrict airflow in various directions based on the use of linear or planar members. For example, a cell may be formed with openings permitting airflow in multiple directions by positioning linear members at the edges of the cell, with no planar members. Adding planar members to a cell may restrict airflow in various directions. The thickness or number of linear members may similarly affect sizes of openings through a cell, and correspondingly affect airflow through the cell. In certain embodiments, a lattice or a plurality of individual beads may be formed of cells with openings permitting airflow, so that the openings permit airflow through the lattice or the beads. In a certain embodiment, openings may permit airflow in multiple directions through a lattice (e.g., two or more directions that are not parallel or anti-parallel). Permitting airflow, in various embodiments, may allow sweat to evaporate, allow heat to dissipate, or the like. In further embodiments, permitting airflow in multiple directions may provide better evaporation, heat dissipation, or the like, than permitting airflow back and forth along only one direction.

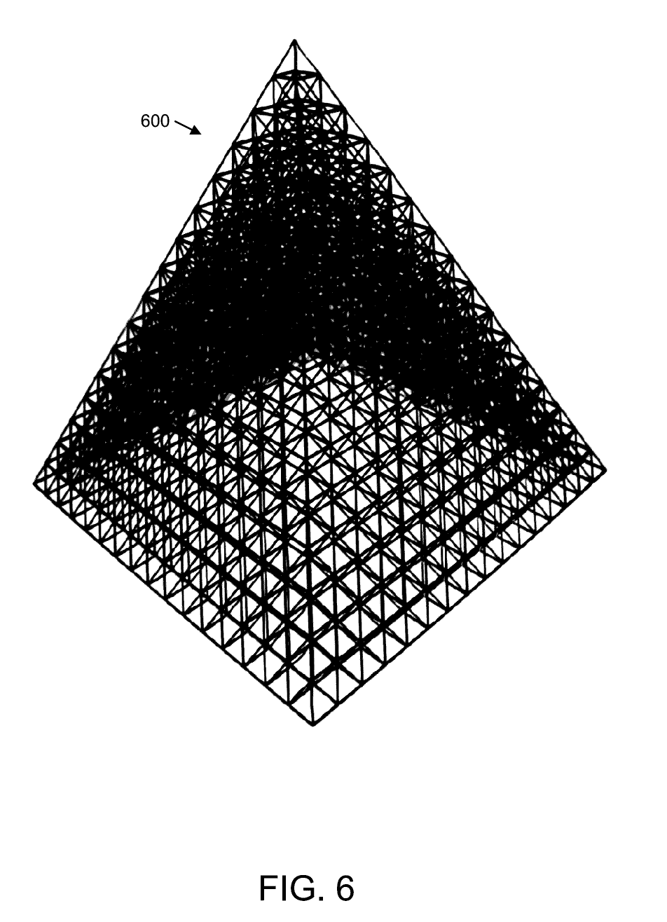

FIG. 6 depicts one embodiment of a lattice 600 of structural members. In the depicted embodiment, linear structural members form pyramidal cells, which are joined to form a larger pyramidal lattice 600. Although both the cells and the lattice 600 are pyramidal in the depicted embodiment, a lattice, in another embodiment, may be another shape, and may include cells of one or more other shapes. Similarly, in the depicted embodiment, a lattice 600 is formed by repeating identical cells. By contrast, in another embodiment, a lattice may be formed randomly or pseudorandomly. For example, in one embodiment, a lattice may be formed by extending linear members in various directions to join two or more planar members. In another embodiment, a lattice may be formed by extruding multiple linear members in different directions, and joining the linear members to form cells at points where the linear members meet.

It may be seen that openings in the lattice 600 permit airflow in multiple directions. An open lattice (or individual beads) with openings in multiple directions may provide a surface that does not easily accumulating sweat, oil, dirt, or the like, because substances may move or be wicked through the lattice instead of accumulating on a surface. Additionally, an open lattice (or individual beads) with openings in multiple directions may be easily rinsed.

In the depicted embodiment, the lattice 600 is formed by additive manufacturing, also referred to as 3D printing. In various embodiments, a lattice may be built up by additive 3D printing techniques that would be impractical to form by molding. For example, lattice 600 would not release from a simple male-female mold. However, in certain embodiments, parts of lattices may be molded and joined together. In various embodiments, the configuration of a lattice 600 or various portions of a lattice 600 may be determined in the additive manufacturing or molding process, so that a single-piece lattice includes different portions with different characteristics. By contrast, foam or gel materials that provide cushioning or otherwise absorb mechanical energy are generally formed by a chemical process that provides uniform characteristics in a single piece. Thus, forming a lattice with different portions having different characteristics may simplify manufacturing processes by reducing assembly steps. For example, a seat back cushion that is softer in some areas and firmer in other areas could be formed as a single piece by configuring characteristics of the lattice and/or protrusions in various areas, thus avoiding the process of joining multiple foam pieces of varying firmnesses.

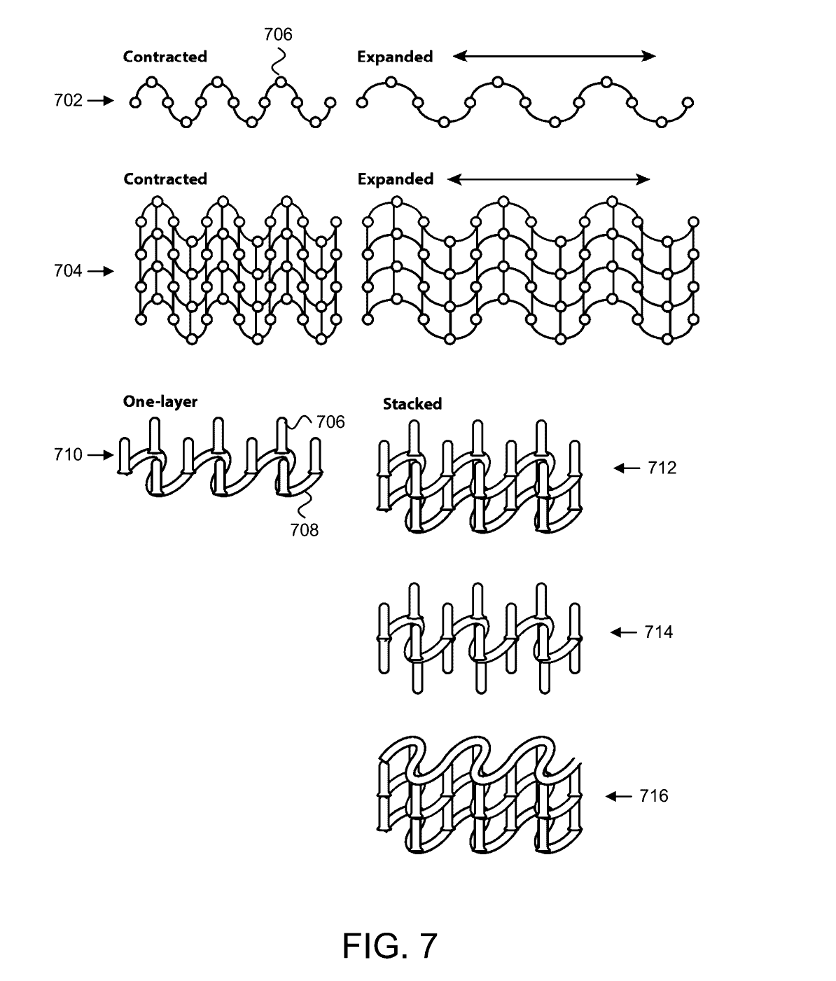

FIG. 7 depicts further embodiments of structural members, including protrusions. In certain embodiments, a lattice of structural members (as described above with regard to FIG. 5 and FIG. 6) may be formed of an elastic material, and may deform by expanding and contracting to absorb mechanical energy. For convenience in depiction, a three-dimensional lattice of cells is not shown. However, lattice 704 is a two-dimensional array, which may correspond, in various embodiments, to one face of a three-dimensional lattice. Similarly, lattice 702 is a one-dimensional array, which may correspond, in various embodiments, to an edge of a three-dimensional lattice. In certain embodiments, a face or edge of a lattice may include protrusions 706, which may be substantially similar to the protrusions described above with regard to FIGS. 1A, 1B, 2, and 3. In certain embodiments, both the lattice 702, 704 and the protrusions 706 may deform to various degrees to absorb mechanical energy. In one embodiment, as a lattice 702, 704 is compressed, protrusions 706 may become more closely spaced. Similarly, in a further embodiment, if a lattice 702, 704 is stretched, protrusions 706 may become further apart. Because protrusions 706 move with the lattice, the protrusions 706 may, in some embodiments, be similar to linear structural members for the lattice. In fact, in certain embodiments, a lattice may be formed from multiple layers including protrusions. Individual layers may, in certain embodiments, be releasable from a simple male-female mold, and may be combined to form more complex lattices.

In one embodiment, a single layer of a lattice 704 may include a base layer 708 and protrusions 706. Base layers 708 and protrusions 706 may be combined in various ways to form various types of lattices. For example, two or more layers 710 may be stacked to form a lattice 712 with protrusions 706 on the top. In another embodiment, an additional layer of protrusions 706 may be added (or a base layer 708 removed) to form a lattice 714 with protrusions 706 on the top and on the bottom. In certain embodiments, a lattice 714 with protrusions 706 on the top and on the bottom may provide an anti-slip surface on both sides. In another embodiment, an additional base layer 708 may be added (or a layer of protrusions 706 removed) to form a lattice 716 without protrusions 706 on the top or the bottom, but with protrusions on the interior, acting as structural members. In certain embodiments, a lattice 716 without protrusions 706 on the top or on the bottom may distribute pressure across a larger area for increased comfort. In the depicted embodiments, lattices 710, 712, 714, and 716 include vertical protrusions. However, in another embodiment, protrusions may extend from a lattice in multiple directions.

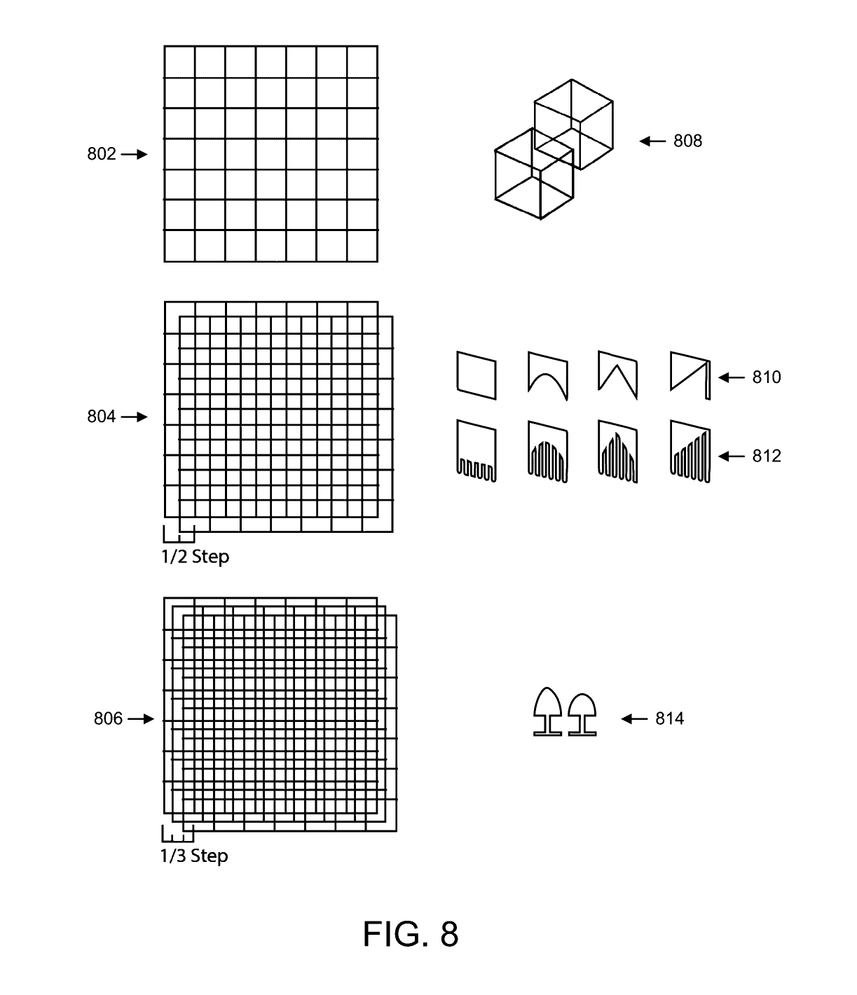

FIG. 8 depicts further embodiments of a lattice of structural members, including protrusions. As described above, a lattice may be formed from a plurality of molded layers. In the depicted embodiment, layer 802 is a grid of cells with a square cross section. Each cell is open at the top and the bottom, but bounded by walls, or planar structural members on the sides. In another embodiment, however, cells may have more or fewer walls or may be shapes other than square. For example in another embodiment, cells may be cylindrical, oval, hexagonal, or another shape.

In certain embodiments, a lattice 804, 806 may include a plurality of molded layers 802, where adjacent layers are offset from each other. One layer 802 may be described as offset from another layer if the layers, are shifted, relative to each other, from a position in which the cells of the layers align. In certain embodiments, where the cells of a layer 802 are of a uniform size, the degree to which one layer is offset from another layer may be described relative to the size of a cell. Moving a layer one full cell in any direction may be described as a step (e.g., the shortest distance between positions in which the cells align). In the depicted embodiment, lattice 804 includes two layers, where adjacent layers are offset by half of a step. Similarly, lattice 806 includes three layers, where adjacent layers are offset by one third of a step. Larger lattices can be formed by stacking lattices such as lattice 804 or lattice 806, or by stacking various numbers of layers, with various offsets. Lattices may be formed from individual layers, by gluing, plastic welding, or otherwise attaching the layers, or simply by stacking the layers.

In general, in various embodiments, offsetting layers by a whole number of steps may align cells, effectively creating taller cells or columns. In another embodiment, however, offsetting layers by a fractional number of steps may cause linear or planar structural members of one layer to intersect (rather than be fully supported by) the structural members of an adjacent layer. For example, cells 808 depict a closer view of a portion of lattice 804, in which layers are offset by half of a step. Where the structural members of the cells 808 intersect, cells may deform to absorb mechanical energy. For example, linear structural members may bend, or planar structural members may distort as layers are compressed. Additionally, airflow may weave between layers that are offset by a fractional number of steps.

In certain embodiments, offsetting layers by a fractional number of steps may allow multiple layers to be molded together using a single male-female mold. For example, although lattice 806 may be formed by attaching layers in one embodiment, the same lattices may be formed in another embodiment using a single mold, with protrusions in the top of the mold corresponding to cell interiors in the top layer, protrusions in the bottom of the mold corresponding to cell interiors in the bottom layer, and protrusions extending from both the top and bottom portions of the mold, and meeting in the middle layer, corresponding to cell interiors in the middle layer.

In certain embodiments layers 802 may include planar structural members (e.g., walls) with openings formed to permit airflow across the layer. For example, in the depicted embodiment, planar structural members 810 include airflow openings of various shapes and sizes. Various configurations of openings may affect airflow and/or deformation of the structural members. In another embodiment, layers 802 may include protrusions as described above. For example, in the depicted embodiment, planar structural members 812 include protrusions of various shapes and sizes. In certain embodiment, top and/or bottom layers may be formed with non-slip protrusions, and middle layers may be formed with airflow openings. In the depicted embodiment, the openings and protrusions are shown in a lower portion of a structural member. In another embodiment, however, openings and protrusions may be formed in an upper portion of a structural member. For example, in lattice 804, openings may be directed downward for the lower layer, and may be directed upward for the upper layer, allowing both layers, including openings, to be molded together using a single mold. Various possible configurations of protrusions and airflow openings for multiple layers will be clear in view of this disclosure.

In one embodiment, protrusions may include a flanged base allowing the protrusions to be removed from the lattice and reinserted into the lattice. For example, in the depicted embodiment, protrusions 814 include a flanged base. Protrusions 814 are depicted in side view for convenience in depicting the flanged base. In various embodiments, protrusions 814 may be rotationally symmetrical, or may have a square or other polygonal cross-section, or the like. In a further embodiment, the lattice or an individual cell may be stretched or distorted to fit the base through the layer. Conversely, compressing the lattice may hold the flanged bases of protrusions 814 more securely in place. Providing removable and reinsertable protrusions may allow a user of an apparatus for absorbing mechanical to configure aspects of the apparatus such as the size, shape, firmness, spacing, or grouping of the protrusions 814. For example, if an apparatus is used as a seat back, mattress pad, or the like, a user may use removable and reinsertable protrusions of different heights and firmnesses in different areas, to provide an effect similar to acupressure or massage.

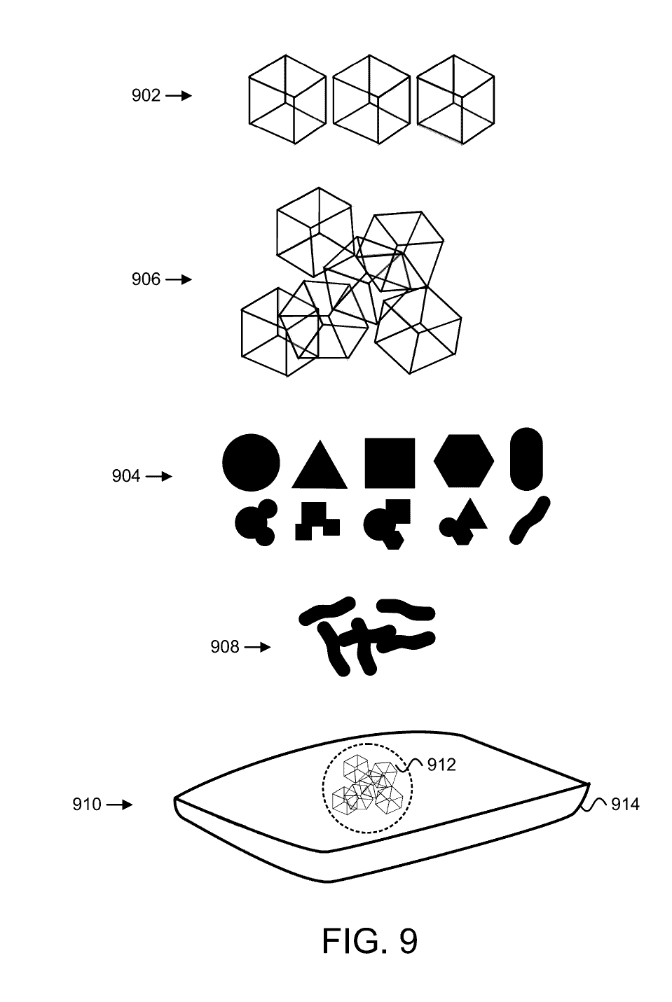

FIG. 9 depicts various embodiments of beads for use with an apparatus for absorbing mechanical energy. As described above, beads may include individual cells formed of structural members, which are not connected to other cells in a lattice structure. In the depicted embodiment, beads 902 vary as to how much of the cell is enclosed by planar structural members. The number of linear or planar structural members for a bead may affect airflow through the bead, or the degree to which the bead deforms in response to pressure.

In the depicted embodiment, beads 904 vary in shape. Various simple or complex shapes may affect the degree to which the bead deforms in response to pressure, the tendency of beads to interlock with other beads, or the like. In certain embodiments, an apparatus for absorbing mechanical energy may include a plurality of beads. In some embodiments, various shapes of beads may be produced by simply produced by molding, and may be combined to provide shock absorption, while openings in the beads provide airflow in multiple directions.

In certain embodiments, a plurality of beads may be simply poured or piled up to form an apparatus for absorbing mechanical energy. For example, a plurality of cubic beads 906, a plurality of packing-peanut shaped beads 908 or the like may be piled up or stacked, and may absorb mechanical energy incident on the beads. In another embodiment, an enclosure may contain the beads. For example, in one embodiment, an enclosure may contain beads to cushion an object outside the enclosure. In the depicted embodiment, a pillow 910 includes beads 912, enclosed by a pillow case 914, to cushion a user's head (outside the pillow case 914). In another embodiment, however, an enclosure may contain beads to cushion an object inside the enclosure. For example, a user may enclose beads in a box to protect an object inside the box. As described above with regard to lattices, beads may include protrusions extending from the bean in any direction.

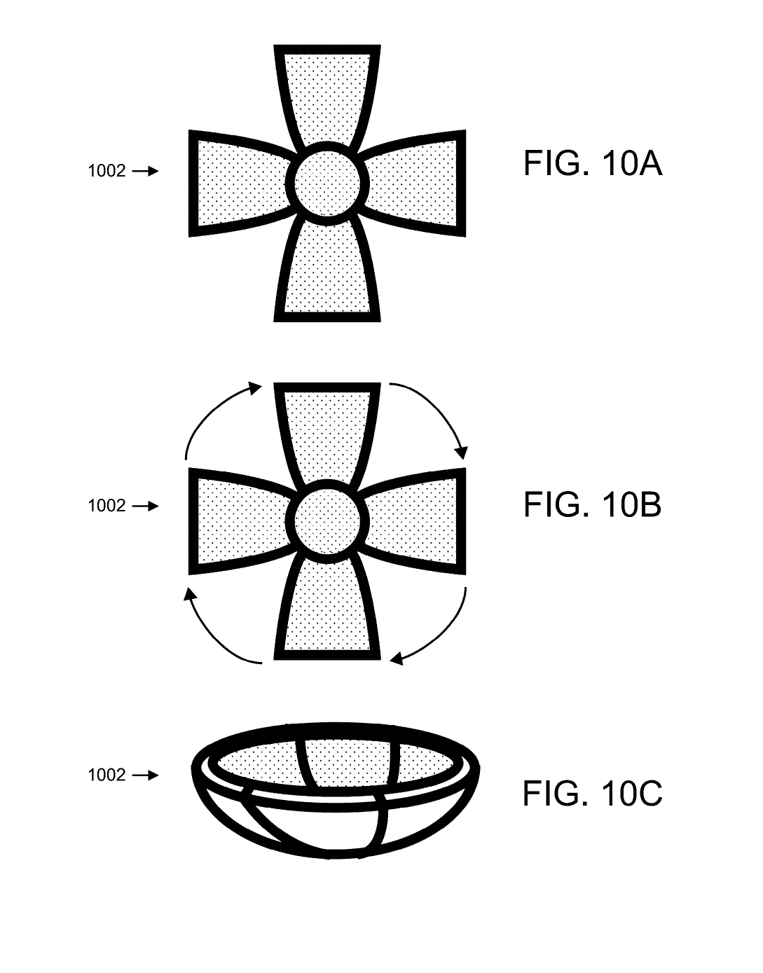

FIG. 10A depicts a flat molding for another embodiment of an apparatus 1002 for absorbing mechanical energy. In various embodiments, an apparatus 1002 for absorbing mechanical energy may be molded as a flat piece with an array of protrusions all pointing in the same direction, so that the molded piece can be removed from the mold. More complex shapes may be formed by folding or bending a flexible, flat-molded piece. For example, FIG. 10A depicts the apparatus 1002 as a flat molded piece, with gaps between portions. FIG. 10B illustrates folding the apparatus 1002 so that portions of the apparatus on either side of a gap meet. FIG. 10C illustrates the shape of the folded apparatus 1002. In the depicted embodiment, the folded apparatus 1002 is in the shape of a dome (e.g., for a knee pad, elbow pad, helmet liner, or the like), and includes protrusions pointing towards the center in various orientations. The dome-shaped apparatus 1002 would be difficult or impossible to remove from a mold if it were molded as a dome, because the protrusions are pointing in various directions, and there would be no one direction to move the apparatus 1002 to unmold it. However, in the depicted embodiment, the apparatus 1002 may be easily removed from a flat mold, and subsequently formed into the dome shape of FIG. 10C. In various further embodiments, additional complex, three-dimensional shapes may be formed in a similar way for an energy-absorbing apparatus 1002.

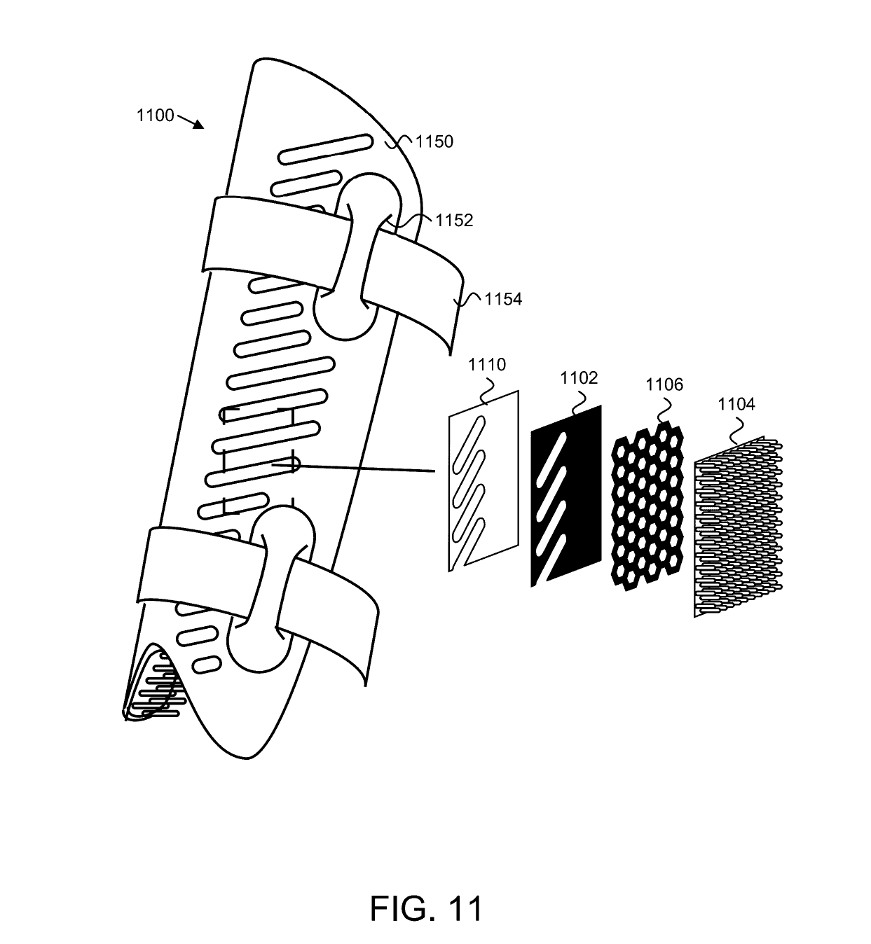

FIGS. 11-14 depict various embodiments of a system for absorbing mechanical energy. In general, in various embodiments, a system for absorbing mechanical energy may include an object that contacts another object, or a surface when the object is in use. In one embodiment, a surface contacted by one object may be a surface of another object. For example, a system for absorbing mechanical energy may include one object, such as a machine, that contacts a surface such as a floor, and the system may damp vibrations that would otherwise be transmitted between the machine and the floor. In another embodiment, the surface may be a surface on a user of the object. For example, an object that is worn, held, stood on, sat on, or the like my contact a surface of a user. In certain embodiments, the object may be in direct physical contact with the user, or may be in indirect physical contact. For example, a user's shoes may be between the user and a floor mat that absorbs mechanical energy, but the user may still be said to be in indirect contact with the floor mat. In certain embodiments, a vented layer may be coupled to the object. For example, a vented layer may be glued to the object, strapped to the object, held to the object by elastic bands, simply resting on the object, or the like. An array of protrusions may extend away from the vented layer such that the protrusions are in contact with the surface when the object is in use. Protrusions in another orientation may also absorb energy, but in certain embodiments, where the protrusions contact a surface of a user's body, the protrusions may allow airflow between the user and the object, so that sweat and body heat may be dissipated. The vented layer, array of protrusions, or structural framework may be substantially as described above with reference to FIGS. 1A and 1B.

FIG. 11 depicts one embodiment of a system 1100 for absorbing mechanical energy. In the depicted embodiment, an object configured to be in physical contact with a surface when the object is in use is a shin guard 1150 that physically contacts a surface of the user's shin. In the depicted embodiment, the system 1100 includes a vented layer 1102 coupled to the shin guard 1150, a structural framework 1106, protrusions 1104, and a hard layer 1110 coupled to the vented layer 1102 to distribute an impact force across the system 1100. The vented layer 1102, structural framework 1106, protrusions 1104, and the hard layer 1110 may be substantially as described above with reference to FIGS. 1A and 1B, like numbers referring to like elements. In the depicted embodiment, loops 1152 are molded into the vented layer 1102 to receive elastic bands 1154 that secure the system 1100 to a user's shin. In certain embodiments, a shin guard 1150 with a vented layer 1102, structural framework 1106, and protrusions 1104, may significantly avoid skin irritation as compared to a shin guard with a foam liner, because sweat evaporates or moves between the protrusions 1104 instead of being retained against the user's skin, and airflow is permitted through the shin guard 1150.

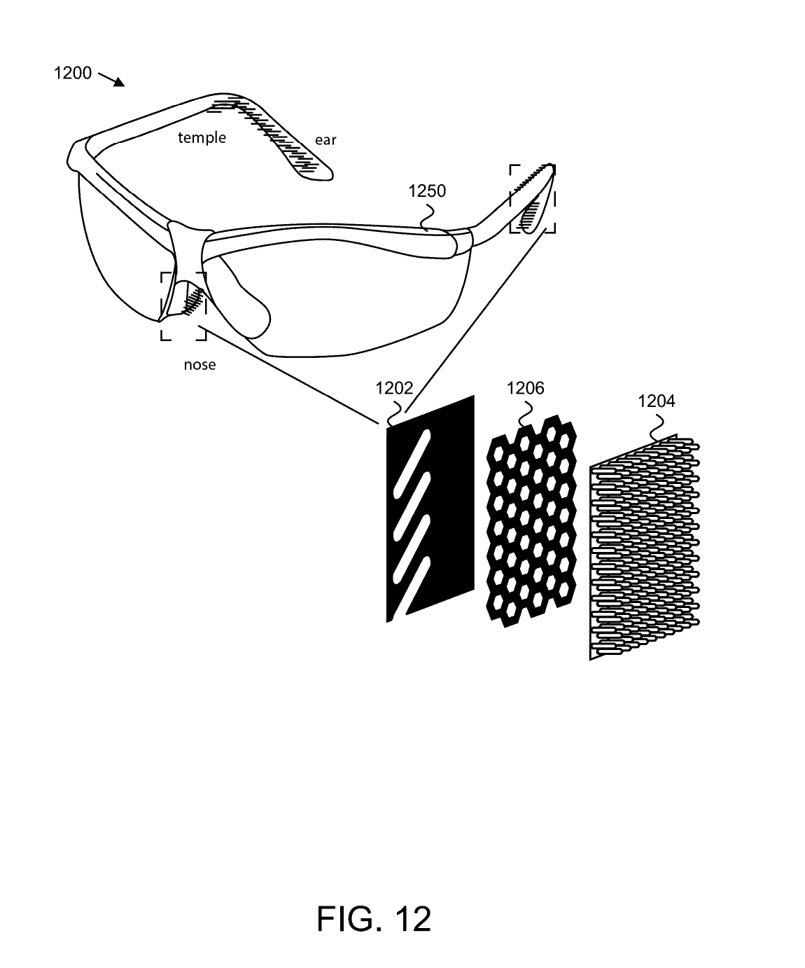

FIG. 12 depicts another embodiment of a system 1200 for absorbing mechanical energy. In the depicted embodiment, an object configured to be in physical contact with a surface when the object is in use is a pair of glasses 1250 that physically contacts one or more surfaces of the user's face. In the depicted embodiment, the system 1200 includes a vented layer 1202 coupled to the glasses 1250, a structural framework 1206, and protrusions 1204, which may be substantially as described above with reference to FIGS. 1A and 1B, like numbers referring to like elements. In the depicted embodiment, the vented layer 1202, structural framework 1206, and protrusions may be coupled to portions of the glasses 1250 that exert pressure on a user, such as a bridge or nose piece, or an ear piece. In certain embodiments, glasses 1250 with a vented layer 1202, structural framework 1206, and protrusions 1204, may be more comfortable for a user than traditional glasses, and may be less prone to slip, particularly when the user sweats.

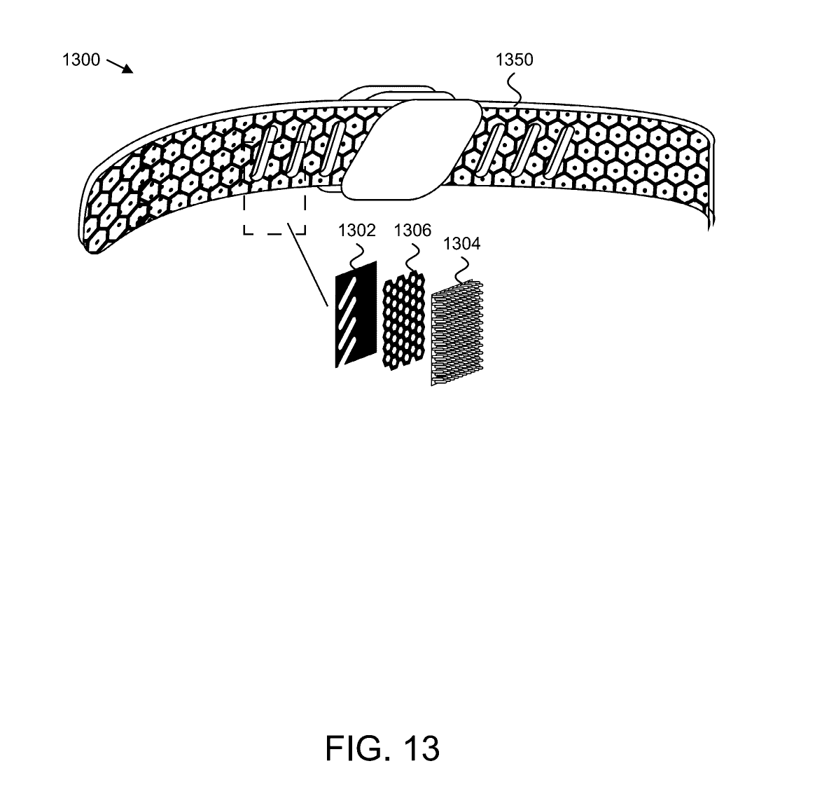

FIG. 13 depicts another embodiment of a system 1300 for absorbing mechanical energy; In the depicted embodiment, an object configured to be in physical contact with a surface when the object is in use is a watch 1350 that physically contacts a surface of the user's wrist. In the depicted embodiment, the system 1300 includes a vented layer 1302 coupled to the watch 1350, a structural framework 1306, and protrusions 1304, which may be substantially as described above with reference to FIGS. 1A and 1B, like numbers referring to like elements. In the depicted embodiment, the vented layer 1302, structural framework 1306, and protrusions 1304 may allow airflow through and around the watch, and may cushion the user's wrist from the pressure exerted by the watch band.

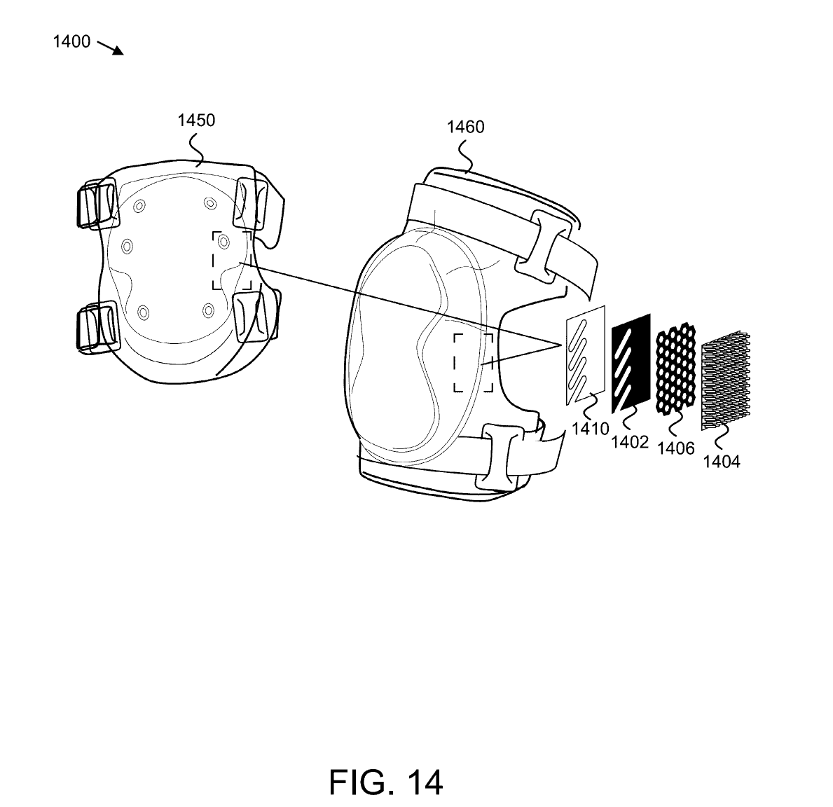

FIG. 14 depicts another embodiment of a system 1400 for absorbing mechanical energy. In the depicted embodiment, an object configured to be in physical contact with a surface when the object is in use is an elbow pad 1450 and/or a knee pad 1460 that physically contacts a surface of a user's elbow or knee. In the depicted embodiment, the system 1400 includes a vented layer 1402 coupled to the elbow pad 1450 or knee pad 1460, a structural framework 1406, protrusions 1404, and a hard layer 1410 coupled to the vented layer 1402 to distribute an impact force across the system 1400. The vented layer 1402, structural framework 1406, protrusions 1404, and the hard layer 1410 may be substantially as described above with reference to FIGS. 1A and 1B, like numbers referring to like elements. In the depicted embodiment, loops and straps may secure the system 1400 to a user's knees and elbows. The loops and straps may be substantially as described above with regard to FIG. 11. In certain embodiments, the vented layer 1402, structural framework 1406, and protrusions 1404 may be molded as a flat piece with gaps and folded to conform to the inner surface of the elbow pad 1450 or knee pad 1460, substantially as described above with reference to FIGS. 10A, 10B, and 10C. In certain embodiments, an elbow pad 1450 or knee pad 1460 with a vented layer 1402, structural framework 1406, and protrusions 1404, may significantly avoid skin irritation as compared to an elbow or knee pad with a foam liner, but may provide a comparable or improved level of impact protection.

In certain embodiments, a method of retrofitting an object (e.g., a shin guard, knee pad, handlebar, backpack strap, seat, or the like) to absorb mechanical energy may include providing a sheet of energy absorbing material. In various embodiments, a “sheet” of energy absorbing material may refer to a flat extent of energy absorbing material, whether in the form of a broad sheet or a narrow tape. The sheet of energy absorbing material may include a vented layer and protrusions as described above with reference to FIGS. 1A and 1B. In one embodiment, the method may include attaching energy absorbing material from the sheet of energy absorbing material to an object. For example, a portion of energy absorbing material may be cut out of the sheet and coupled to the object via elastic straps, an adhesive, or the like, or a narrow sheet or tape of energy absorbing material may be wrapped around an object. In certain embodiments, the method may include removing existing absorbing material, such as foam, or the like, from the object, and replacing the removed material with energy absorbing material from the sheet.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a vented layer formed with a plurality of vent openings, a vent opening comprising a channel extending through the vented layer to permit airflow through the vented layer; and
an array of protrusions extending away from the vented layer, the array of protrusions allowing air from the vent openings to flow between the protrusions, wherein the protrusions absorb energy by deformation such that one or more of the protrusions deforms significantly by bending toward the vented layer.

2. The apparatus of claim 1, further comprising a structural framework comprising an array of linear members that extend along and are coupled to the vented layer.

3. The apparatus of claim 2, wherein the vented layer, the protrusions, and the structural framework are formed integrally as a single piece of polymer material.

4. The apparatus of claim 1, wherein the array of protrusions is formed to manage airflow between the protrusions

5. The apparatus of claim 1, wherein one or more of the protrusions comprises a rounded tip.

6. The apparatus of claim 1, wherein the array of protrusions includes at least a first type of protrusion and a second type of protrusion, the second type different from the first type.

7. The apparatus of claim 6, wherein a configuration for a first portion of the array of protrusions differs from a configuration for a second portion of the array of protrusions.

8. The apparatus of claim 7, further comprising a first modular piece removably coupled to a second modular piece, the first modular piece comprising the first portion of the array of protrusions and the second modular piece comprising the second portion of the array of protrusions.

9. The apparatus of claim 1, wherein a configuration for the array of protrusions is based on one or more measured characteristics of a surface the protrusions are configured to contact.

10. The apparatus of claim 1, further comprising a hard layer coupled to the vented layer to distribute an impact force across the apparatus, the hard layer comprising a plurality of vent openings corresponding to vent openings of the vented layer.

11. The apparatus of claim 1, wherein the vented layer is coupled to a first object such that the protrusions contact a second object when the first object is in use.

12. The apparatus of claim 1, wherein the vented layer and the protrusions are molded as a flat piece and bent to form a three-dimensional shape.

13. An apparatus comprising
a lattice of structural members, the structural members comprising one or more of linear members and planar members,
wherein the lattice is formed with a plurality of openings within the lattice, the openings permitting airflow in multiple directions through the lattice,
wherein the lattice absorbs mechanical energy by deformation.

14. The apparatus of claim 13, wherein the lattice is formed by additive manufacturing.

15. The apparatus of claim 13, wherein the lattice comprises a plurality of molded layers, wherein a first layer of the plurality of molded layers is offset from a second layer of the plurality of molded layers, the second layer adjacent to the first layer.

16. The apparatus of claim 13, further comprising a plurality of protrusions extending from the lattice.

17. The apparatus of claim 16, wherein one or more protrusions of the plurality of protrusions comprises a flanged base allowing the one or more protrusions to be removed from the lattice and reinserted into the lattice.

18. The apparatus of claim 13, wherein a configuration for a first portion of the lattice differs from a configuration for a second portion of the lattice.

19. An apparatus comprising
a plurality of beads, the beads comprising structural members, the structural members comprising one or more of linear members and planar members,
wherein the beads are formed with openings permitting airflow through the beads,
wherein the beads absorb mechanical energy by deformation; and
an enclosure that contains the beads.

20. The apparatus of claim 19, wherein the plurality of beads comprises at least a first type of bead and a second type of bead, the second type different from the first type.
